(19) United States
(12) Patent Application Publication
(10) Pub. No.: US 2026/0111285 A1
(43) Pub. Date: Apr. 23, 2026

(54) MANAGING NETWORK COMMUNICATIONS FOR A DATA PROCESSING SYSTEM USING A MANAGEMENT CONTROLLER

(71) Applicant: Dell Products L.P., Round Rock, TX (US)

(72) Inventors: ADOLFO SANDOR MONTERO, Pflugerville, TX (US); RICHARD M. TONRY, Georgetown, TX (US); BASSEM EL-AZZAMI, Austin, TX (US); VINODKUMAR VASUDEV OTTAR, McKinney, TX (US); ABEYE TESHOME, Austin, TX (US); LUIS ANTONIO VALENCIA REYES, Waxahachie, TX (US); MOHIT ARORA, Frisco, TX (US); RAJARAVI CHANDRA KOLLARAPU, Allen, TX (US)

(21) Appl. No.: 18/920,111

(22) Filed: Oct. 18, 2024

(51) Int. Cl. G06F 9/50; H04L 9/40

(52) U.S. Cl. CPC G06F 9/5055; H04L 63/0227

(57) ABSTRACT

Methods and systems for managing network communications of a data processing system are disclosed. The method may include identifying that a firewall hosted by hardware resources of the data processing system may be unavailable. When identified, a management controller may intercept network data directed to the hardware resources from remote entities. To do so, a network module of the data processing system may be utilized. The network data may be screened, by the management controller, based on a firewall policy hosted by the management controller to identify a privileged portion of the network data. The privileged portion of the network data may be redirected to the hardware resources for use in providing computer-implemented services.

### FIELD

Embodiments disclosed herein relate generally to managing network communications for a data processing system. More particularly, embodiments disclosed herein relate to managing network communications for a data processing system by using a firewall hosted by a management controller of the data processing system when a firewall hosted by hardware resources of the data processing system is unavailable.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1C show diagrams illustrating a system in accordance with an embodiment.

FIGS. 2A-2B show interaction diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing network communications for a data processing system. The data processing system may provide computer-implemented services to any type and number of other devices and/or users of the data processing system. The computer-implemented services may include any quantity and type of such services.

To provide the computer-implemented services, the data processing system may obtain resources from any number and/or types of remote entities. To do so, a remote entity of the remote entities may transmit network data to hardware resources of the data processing system. The network data may include information relevant to supporting operation of the data processing system. To prevent unauthorized communication of network data (e.g., malicious data), the hardware resources may host a firewall.

Because the hardware resources may be inoperable under certain conditions (e.g., an unavailability of at least a portion of the hardware resources), operation of the data processing system may also be managed by out-of-band components that may communicate with a remote entity via an out-of-band communication channel. The out-of-band components and the out-of-band communication channel may function independently from in-band components.

The firewall hosted by the hardware resources may be unavailable when an operating system hosted by the hardware resources is not in an operable state (e.g., based on a power state of the data processing system, while the data processing system is performing a booting process, etc.). While the firewall hosted by the hardware resources is unavailable, the hardware resources may require access to the network data communicated by the remote entities. However, the hardware resources may be unable to obtain the network data and/or may be vulnerable to attacks by malicious entities communicating network data while the firewall is unavailable.

To reduce a likelihood that computer-implemented services may be impacted when the firewall hosted by the hardware resources is unavailable, the management controller may screen network data directed to the hardware resources to identify and/or redirect a privilege portion of the network data to the hardware resources.

To do so, the management controller may identify an indicator of an unavailability of the firewall hosted by the hardware resources. When identified, the management controller may intercept network data directed to the hardware resources, for example, by providing instructions to a network module of the data processing system to redirect the network data to the management controller.

The network data may be screened by the management controller based on a firewall policy hosted by the management controller to identify a privileged portion of the network data and/or an unprivileged portion of the network data. The unprivileged portion of the network data may be prevented from reaching the hardware resources, and the privileged portion of the network data may be redirected to the hardware resources. The hardware resources may subsequently use the privileged portion of the network data to provide the computer-implemented services.

Thus, embodiments disclosed herein may provide an improved method for managing network communications for a data processing system by using a firewall hosted by a management controller of the data processing system when a firewall hosted by hardware resources of the data processing system is unavailable. By doing so, an availability and/or security of computer-implemented services provided by the data processing system may be improved.

In an embodiment, a method for managing network communications for a data processing system is provided. The method may include: (i) identifying, by a management controller of the data processing system, an indicator of an unavailability of a firewall hosted by hardware resources of the data processing system; (ii) based on the identifying: (a) intercepting, by the management controller, network data directed to the hardware resources, the network data comprising messages sent between a remote entity and the data processing system to support operation of the data processing system; (b) screening, by the management controller, the network data based on a firewall policy to identify a privileged portion of the network data and an unprivileged portion of the network data; (c) redirecting, by the management controller, the privileged portion of the network data to the hardware resources and prevent the unprivileged portion of the network data from reaching the hardware resources; and (d) providing, by the hardware resources, computer-implemented services using the privileged portion of the network data.

Identifying the indicator of an unavailability of the firewall may include: (i) monitoring a power state of the hardware resources of the data processing system; (ii) identifying that the hardware resources are performing a booting process; and (iii) identifying that the hardware resources are in a potentially compromised state with respect to the firewall.

The firewall may be unavailable when an operating system hosted by the hardware resources is not in an operable state based on the power state of the hardware resources and/or the booting process performed by the hardware resources.

Intercepting the network data may include: (i) providing, by the management controller, instructions for a network module of the data processing system to redirect the network data to the management controller.

The hardware resources and the network module may be adapted to separately advertise network endpoints for the management controller and the hardware resources, the network endpoints being usable by the remote entity to address communications to the hardware resources using an in-band communication channel and the management controller using an out-of-band communication channel.

The management controller and the network module may be on separate power domains from the hardware resources so that the management controller and the network module are operable while the hardware resources are inoperable.

The out-of-band communication channel may run through the network module, and an in-band communication channel that services the hardware resources may also run through the network module.

The network module may host a transmission control protocol/internet protocol (TCP/IP) stack to facilitate network communications via the out-of-band communication channel.

The firewall policy may include a set of rules for preventing unauthorized communication between remote entities and the hardware resources.

Screening the network data may include performing at least one action from a group of actions consisting of: (i) comparing an identity of the remote entity to a whitelist and/or a blacklist indicated by the set of rules; and (ii) analyzing traffic patterns to identify potential communication activity that does not adhere to the firewall policy.

Redirecting the privileged portion of the network data may include forwarding the privileged portion of the network data to the hardware resources via a side band communication channel.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

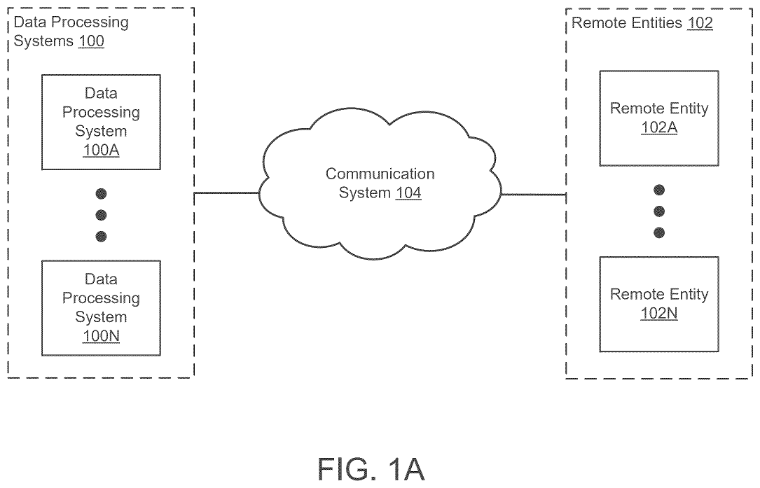

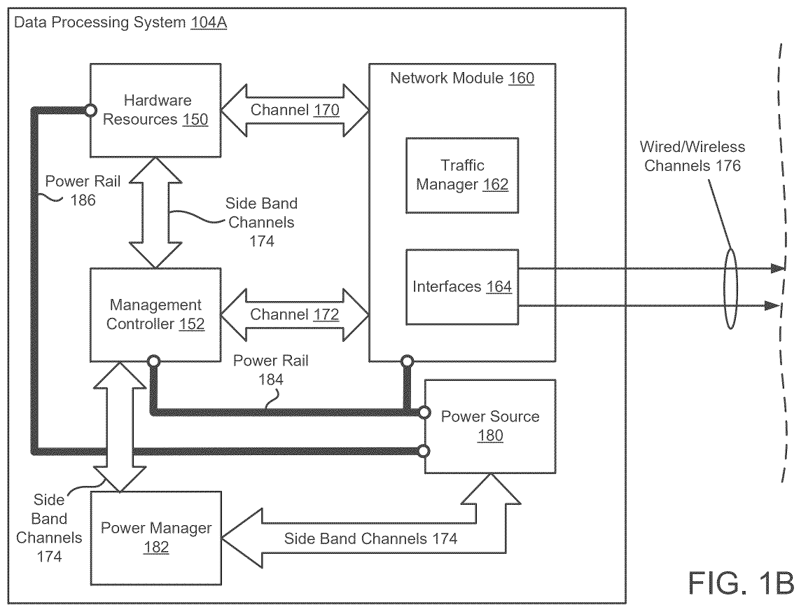

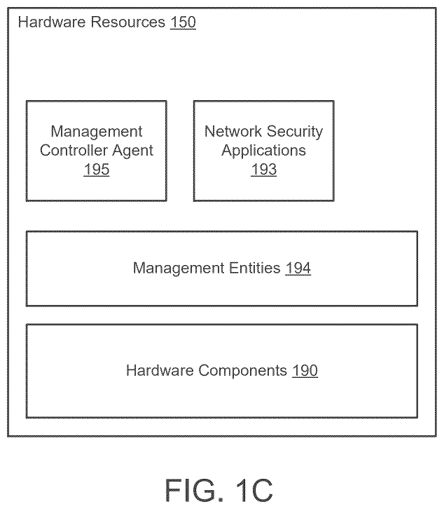

Turning to FIG. 1A, a block diagram illustrating a system in accordance with an embodiment is shown. The system shown in FIG. 1A may provide for management of data processing systems that may provide, at least in part, computer-implemented services (e.g., to user of the system and/or devices operably connected to the system).

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time. Refer to FIGS. 1B-1C for additional details regarding data processing systems 100.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, remote entities 102, and/or any other type of devices (not shown in FIG. 1A). Other types of computer-implemented services may be provided by the system shown in FIG. 1A without departing from embodiments disclosed herein.

To manage operation of a data processing system (e.g., 100A), data processing system 100A may include a management controller. The management controller may operate independently from the hardware resources of data processing system 100A and may therefore provide management functionalities for data processing system 100A regardless of a status of one or more in-band components (e.g., the hardware resources). To do so, the management controller may obtain information from the hardware resources. In addition, the management controller may receive information from and/or provide information to remote entities 102 without the information traversing the in-band components.

The computer-implemented services may be provided, at least in part, by hardware resources of data processing system 100A and the computer-implemented services may be desired by a user of data processing system 100A.

To provide the computer-implemented services, the hardware resources may obtain network data from remote entities 102 that may be usable to support operation of data processing system 100. For example, the hardware resources may obtain a file (e.g., an optical disc image) from a remote entity (e.g., 102A) of remote entities 102 for use in provisioning an operating system, restoring a version of an application (e.g., that may be corrupted), and/or any other purposes.

Because a data processing system may be vulnerable to attacks (e.g., unauthorized access, malicious traffic, data breaches, etc.) by malicious entities, the hardware resources may host a firewall (e.g., a security system that monitors and controls network traffic to protect a computer or network from unauthorized access) to manage communication of the network data with remote entities 102. For example, the firewall may prevent unauthorized communication between remote entities 102 and the hardware resources by implementing a policy (e.g., a whitelist, a blacklist, etc.) that may be hosted by the hardware resources.

However, the firewall hosted by the hardware resources may be unavailable when an operating system hosted by the hardware resources is not in an operable state. For example, the firewall may be unavailable when a power state of the hardware resources is in an off state, when the hardware resources are performing a booting process (e.g., initiating devices required for operation of the hardware resources, loading the operating system into a main memory of the hardware resources, etc.), and/or any other conditions that may impact an ability of the firewall to provide its functionality. The firewall may be unavailable for other reasons.

In general, embodiments disclosed herein may provide methods, systems, and/or devices for managing network communication for a data processing system. To reduce a vulnerability of hardware resources of a data processing system when a firewall hosted by the hardware resources is unavailable, network traffic directed to the hardware resources may be screened by a firewall hosted a management controller of the data processing system. When an indicator of an unavailability of the firewall hosted by the hardware resources is identified, the management controller may intercept network data directed to the hardware resources, and screen the network data to identify a privileged portion of the network data to redirect to the hardware resources. By doing so, a quality and/or availability of computer-implemented services provided by data processing systems 100 may be improved.

To identify the indicator of the unavailability of the firewall hosted by the hardware resources, the management controller may monitor a power state of the hardware resources, identify that the hardware resources are performing a booting process, identify that a network module of the data processing system is in a potentially compromised state with respect to the firewall, and/or perform any other actions.

When identified, the management controller may provide instructions to the network module to redirect the network data to the management data. For example, because the hardware resources and the network module may be adapted to separately advertise network endpoints for the management controller and the hardware resources, communications from remote entities 102 directed to the hardware resources may instead be redirected, by the network module, to a network addressable endpoint of the management controller (e.g., so that the network data does not directly reach the hardware resources).

The management controller may subsequently screen the network data to identify a privileged portion of the network data and an unprivileged portion of the network data. For example, to screen the network data, the management controller may compare an identity of a remote entity to a whitelist (e.g., a list of network addressable endpoints that are allowed to communicate with the hardware resources) and/or a blacklist (e.g., a list of network addressable endpoints that are not allowed to communicate with the hardware resources), analyze traffic patterns, and/or perform any other actions to identify communication that may not adhere to a firewall policy hosted by the management controller.

Once identified, the privileged portion of the network data may be provided to the hardware resources and the unprivileged portion of the network data may be prevented from reaching the hardware resources. The hardware resources may subsequently use at least the privileged portion of the network data to provide desired computer-implemented services.

To provide the above noted functionality, the system may include data processing systems 100, and remote entities 102. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., management controller, network modules, etc.), and functionality that may allow the out-of-band components to communicate with remote entities 102 via an out-of-band communication channel.

While providing the at least a portion of the computer-implemented services, a data processing system (e.g., 100A) of data processing systems 100 may communicate with and/or utilize network data obtained from remote entities 102. Communication of the network data may be screened by a firewall to prevent unauthorized communication between hardware resources of data processing system 100A and a remote entity of remote entities 102. By doing so, a risk of malicious network data negatively impacting computer-implemented services provided by data processing system 100A may be mitigated.

Remote entities 102 may, as discussed above, provide remote management services. To provide the remote management services, remote entities 102 may interact with data processing systems 100 to provide information and/or resources relevant to operation of data processing systems 100. For example, remote entities 102 may send files (e.g., disc images, repair files, etc.), updates to firmware and/or drivers used by data processing systems 100, and/or any other information based on a request provided by a data processing system of data processing systems 100.

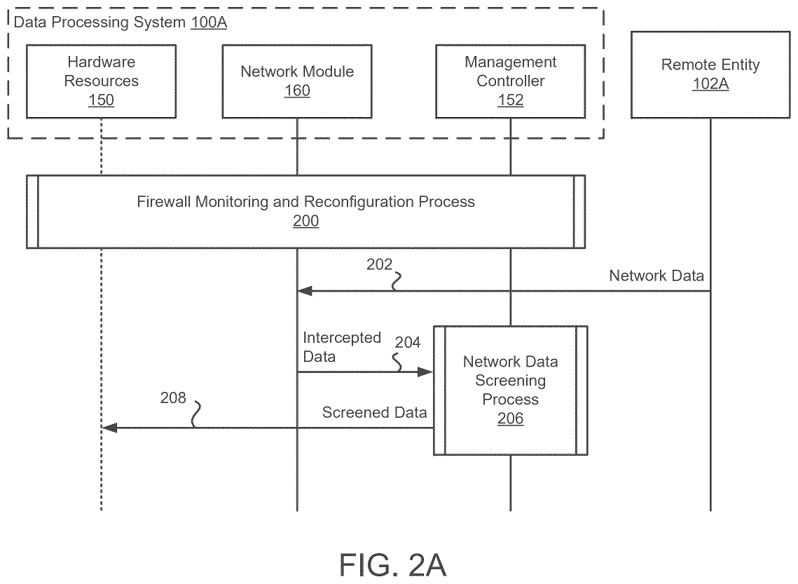

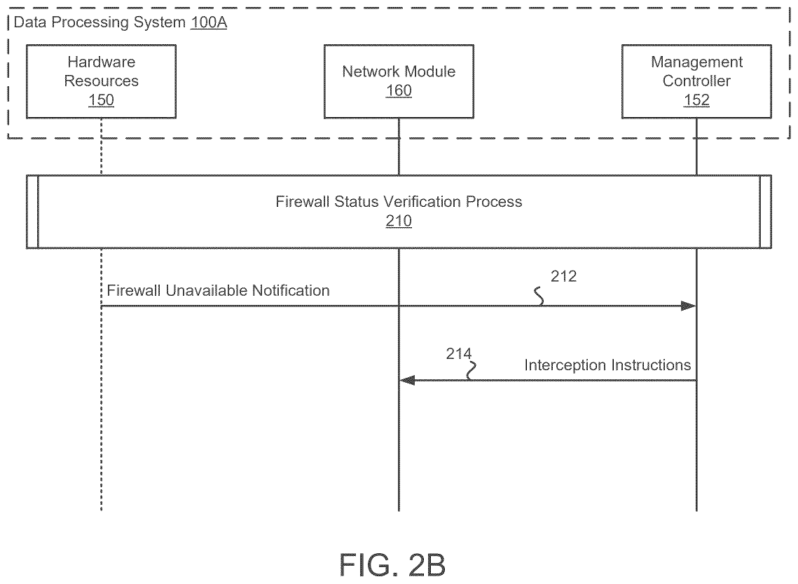

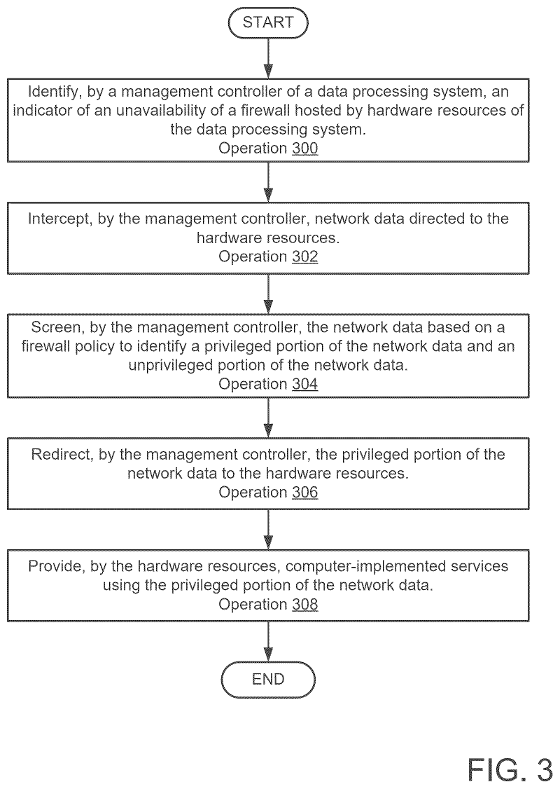

While providing their functionality, any of data processing systems 100 and/or remote entities 102 may provide all or a portion of the methods shown in FIGS. 2A-3.

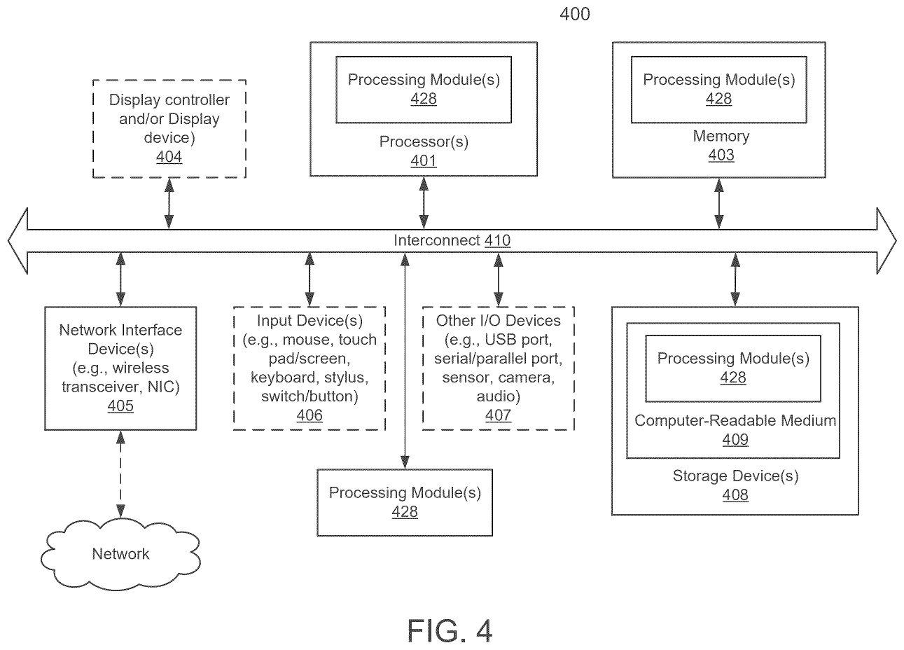

Communication system 104 may allow any of data processing systems 100, and remote entities 102 to communicate with one another (and/or with other devices not illustrated in FIG. 1A). To provide its functionality, communication system 104 may be implemented with one or more wired and/or wireless networks. Any of these networks may be a private network (e.g., the “Network” shown in FIG. 4), a public network, and/or may include the Internet. For example, data processing systems 100 may be operably connected to remote entities 102 via the Internet. Data processing systems 100, remote entities 102, and/or communication system 104 may be adapted to perform one or more protocols for communicating via communication system 104.

Any of (and/or components thereof) data processing systems 100, and remote entities 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may manage network communications for a data processing system of data processing systems 100 by reconfiguring a flow of network data to be screened by a management controller of the data processing system when a firewall hosted by hardware resources of the data processing system is unavailable. By doing so, risks associated with communication between a data processing system and remote entity may be mitigated.

While illustrated in FIG. 1A with a limited number of specific components, a system may include additional, fewer, and/or different components without departing from embodiments disclosed herein.

Turning to FIG. 1B, a diagram illustrating a data processing system in accordance with an embodiment is shown. Data processing system 100A shown in FIG. 1B may be similar to any of the data processing systems shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing hardware resources 150 to communicate with other devices via packet switched networks and/or other types of communication networks.

The processor may also host various applications that provide the computer-implemented services. The applications may utilize various services provided by the management entities and use (at least indirectly) the network stack to communication with other entities.

While communicating with the other devices (e.g., remote entities), hardware resources 150 may screen the data using a firewall hosted by hardware resources 150. The firewall may include, for example, a set of rules applied via an executable process and/or application hosted on an operating system of hardware resources 150.

However, the firewall may be unavailable when the operating system is not in an operable state based on a power state of hardware resources 150. For example, when hardware resources 150 are performing a booting process, operation of the operating system may not be initiated, applications may not be executable, and the firewall may subsequently be disabled.

To reduce a likelihood that hardware resources 150 may be subject to malicious data while the firewall hosted by hardware resources 150 is unavailable, communication of network data with remote entities may be managed by a management controller of data processing system 100A. To manage the network communication, data processing system 100A may include management controller 152 and network module 160. Each of these components of data processing system 100A is discussed below.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band component, may manage power distribution, thermal management, and/or other functions of data processing system 100A.

To do so, management controller 152 may be operably connected to various components via sideband channels 174 (in FIG. 1B, a limited number of sideband channels are included for illustrative purposes, it will be appreciated that management controller 152 may communication with other components via any number of sideband channels). The sideband channels may be implemented using separate physical channels, and/or with a logical channel overlay over existing physical channels (e.g., logical division of in-band channels). The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to identify at least an indicator of an unavailability of a firewall hosted by hardware resources 150, management controller 152 may obtain information regarding a status of the firewall. To do so, management controller 152 may (i) monitor a power state of hardware resources 150, (ii) obtain a list of executing processes from a processor hosted by hardware resources 150, (iii) identify an execution status of the firewall, (iv) transmit a request (e.g., via an in-band communication channel) to hardware resources 150 regarding the firewall, and/or any other processes.

When identified that the firewall hosted by hardware resources 150 may be unavailable, management controller 152 may intercept network data directed to hardware resources 150. Once intercepted, management controller 152 may screen the network data based on a firewall policy to identify a privileged portion of the network data. The privileged portion of the network data may subsequently be provided to hardware resources 150.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 100A may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

For example, to intercept network data directed to hardware resources 150 (e.g., the in-band components) when a firewall hosted by hardware resources 150 is unavailable, management controller 152 may transmit network flow reconfiguration instructions to network module 160. The network flow reconfiguration instructions may include, for example, instructions to re-direct all communication from remote entities to a network endpoint of hardware resources 150 to a network endpoint of management controller 152 instead.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2A-3.

While illustrated in FIG. 1B with a limited number of specific components, a system may include additional, fewer, and/or different components without departing from embodiments disclosed herein.

Turning to FIG. 1C, to provide computer-implemented services, hardware resources 150 may host management entities 194 and network security applications 193. Management entities 194 may include, for example, drivers, operating systems, and/or other entities that facilitate operation of network security applications 193 by facilitating use of hardware components 190. Hardware components 190 may include processors, memory modules, storage devices, and/or other types of hardware components usable to provide computer-implemented services.

Network security applications 193 may provide any quantity and type of network security services using hardware components 190. For example, the applications may make calls to an operating system which in turn makes calls to drivers which in turn communicate with the hardware components to invoke their various functionalities. Network security applications 193 may include, for example, a firewall application adapted to apply a set of rules for preventing unauthorized network communication.

To facilitate cooperation between management controller 152 and hardware resources 150, hardware resources 150 may host management controller agent 195. Management controller agent 195 may be independent from operating system environments, and may facilitate communication with and performance of instructions by management controller 152.

For example, management controller agent 195 may include functionality to (i) monitor various operating system environments, and components therein, (ii) identify a status of a firewall application, (iii) identify operating states (e.g., nominal, stalled, in error of various levels of severity), (iv) obtain information regarding the states of the environments such as, for example, content of memory, processors, logs of operation of various software and/or hardware components, and/or perform other types of management actions through which information regarding the operation of entities hosted by hardware components 190 may be collected.

While illustrated in FIG. 1C with a limited number of specific components, a system may include additional, fewer, and/or different components without departing from embodiments disclosed herein.

To further clarify embodiments disclosed herein, an interaction diagram in accordance with an embodiment is shown in FIGS. 2A-2B. The interaction diagram may illustrate how data may be obtained and used within the system of FIGS. 1A-1C.

In the interaction diagrams, processes performed by and interactions between components of a system in accordance with an embodiment are shown. In the diagrams, components of the system are illustrated using a first set of shapes (e.g., 150, 160, etc.), located towards the top of each figure. Lines descend from these shapes. Processes performed by the components of the system are illustrated using a second set of shapes (e.g., 200, 206, etc.) superimposed over these lines. Interactions (e.g., communication, data transmissions, etc.) between the components of the system are illustrated using a third set of shapes (e.g., 202, 204, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202 may occur prior to the interaction labeled as 204. However, it will be appreciated that the processes and interactions may be performed in different orders, any may be omitted, and other processes or interactions may be performed without departing from embodiments disclosed herein.

The lines descending from some of the first set of shapes (e.g., 150) is drawn in dashing to indicate, for example, that at least a portion of the corresponding components may not be (i) operable, (ii) powered on, (iii) present in the system, and/or (iv) not participating in operation of the system for other reasons.

Turning to FIG. 2A, a first interaction diagram in accordance with an embodiment is shown. The first interaction diagram may illustrate processes and interactions that may occur during screening of network data directed to hardware resources of a data processing system.

To screen network data directed to the hardware resources, firewall monitoring and reconfiguration process 200 may be performed. During firewall monitoring and reconfiguration process 200, an unavailability of the firewall hosted by hardware resources 150 may be identified, and a flow of network data may be reconfigured to screened by management controller 152. For example, to identify the unavailability of the firewall hosted by hardware resources, management controller 152 may: (i) monitor a power state of hardware resources 150, (ii) transmit a request to hardware resources 150 for information regarding a status of the firewall, (iii) obtain an event log of activity relevant the firewall, (iv) receive a notification regarding a compromised state of the firewall, and/or any perform any other actions.

The firewall hosted by hardware resources 150 may be unavailable, for example, when a booting process is being performed by data processing system 100A during which an operating system hosted by hardware resources 150 may be unable to provide computing resources required to facilitate communication of network data and/or host the firewall to screen the network data. In FIG. 2A, the line descending from hardware resources 150 is shown in short-dashed lines to indicate an unavailability of the firewall hosted by hardware resources 150.

When identified that the firewall hosted by hardware resources 150 is unavailable, the flow of network data may be reconfigured to be screened by management controller 152 by (i) transmitting instructions to network module 160 to redirect network data to management controller 152, (ii) providing a network addressable endpoint of management controller 152 to receive the network data, and/or performing any other actions. Refer to FIG. 2B for additional details regarding reconfiguring flow of network data based on a status of the firewall hosted by hardware resources of the data processing system.

At interaction 202, network data may be provided to network module 160 by remote entity 102A. To generate and provide the network data to network module 160, remote entity 102A may (i) transmit the network data via a message to a network addressable endpoint of network module 160, (ii) store the network data in a storage with subsequent retrieval by management controller 152, (iv) participate in a publish-subscribe system where management controller 152 subscribes to updates from remote entity 102A thereby causing a copy of the network data to be propagated to management controller 152, and/or via other processes.

At interaction 204, the intercepted data may be provided to management controller 152 by network module 160. To provide the network data to management controller 152, network module 160 may (i) transmit (e.g., via an out-of-band communication channel) the network data via a message to management controller 152, (ii) modify a network addressable endpoint of the intercepted data to be redirected to management controller 152, and/or perform any other actions.

To identify a privileged portion of the network data, network data screening process 206 may be performed. During network data screening process 206, the network data may be screened based on a firewall policy hosted by management controller 152. For example, to screen the network data, management controller 152 may (i) compare an identify of remote entity 102A to a whitelist to identify allowable sources of the network data, (ii) compare an identify of remote entity 102A to a blacklist to identify restricted sources of the network data, analyze traffic patterns to identify potential communication activity that does not adhere to the firewall policy, and/or perform any other actions. By doing so, management controller may identify a privileged portion of the network data and/or an unprivileged portion of the network data.

At interaction 208, screened data may be provided to hardware resources 150. For example, the screened data may be generated and provided to hardware resources 150 by: (i) transmitting (e.g., via a side-band communication channel) a message including the privileged portion of the network data to hardware resources 150, (ii) repackaging the privileged portion of the network data, (iii) storing the screened data in memory for subsequent retrieval by hardware resources 150, and/or performing any other actions.

Thus, processes and interactions shown in FIG. 2A, a network data directed to hardware resources of a data processing system may obtain may be screened by a management controller of the data processing system when a firewall hosted by the hardware resources is unavailable. By doing so, a security and/or availability of computer-implemented services provided by the data processing system may be improved.

Turning to FIG. 2B, a second interaction diagram in accordance with an embodiment is shown. The second interaction diagram may illustrate processes and interactions that may occur during identification of an unavailability of a firewall hosted by hardware resources of a data processing system.

To identify that the firewall hosted by the hardware resources is unavailable, firewall status verification process 210 may be performed. During firewall status verification process 210, information regarding the firewall may be obtained. For example, to obtain the information regarding the firewall, management controller 152 may (i) monitor a power state of hardware resources 150, (ii) obtain a list of executing processes from a processor hosted by hardware resources 150, (iii) identify an execution status of the firewall, (iv) transmit a request to hardware resources 150 regarding the firewall, and/or any other processes.

At interaction 212, a firewall unavailable notification may be provided to management controller 152 by hardware resources 150. For example, the firewall unavailable notification may be generated and provided to management controller 152 by: (i) providing a list of executing processes that may indicate that the firewall is not active, (ii) transmitting a response based on a request from management controller 152 and/or management controller agent 195, (ii) providing an indication that hardware resources 150 is not in an operable power state, and/or any other processes.

At interaction 214, interception instructions may be provided to network module 160 by management controller 152. The interception instructions may be generated and provided to network module 160 by: (i) providing a network addressable endpoint of management controller 152 to receive the network data, (ii) providing instructions to prevent the network data from reaching hardware resources 150, and/or any other processes.

Thus, processes and interactions shown in FIG. 2B, a flow of network data may be reconfigured to be redirected to a management controller of a data processing system when a firewall hosted by hardware resources of the data processing system is identified to be unavailable. By doing so, the network data may be screened based on a firewall hosted by the management controller.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1C may perform various methods to manage a data processing system. FIG. 3 illustrates a method that may be performed by the components of the system of FIGS. 1A-1C. In the diagrams discussed below and shown in FIG. 3, any of the operations may be repeated, performed in different orders, and/or performed in parallel with or in a partially overlapping in time manner with other operations.

Turning to FIG. 3, a flow diagram illustrating a method of managing network communications for a data processing system in accordance with an embodiment is shown. The method may be performed, for example, by any of the components of the system of FIGS. 1A-1C, and/or other components not shown therein.

At operation 300, an indicator of an unavailability of a firewall hosted by hardware resources 150 may be identified by management controller 152. The indicator may be identified by: (i) monitoring, by management controller 152, a power state of hardware resources 150, (ii) identifying that hardware resources 150 is performing a booting process (e.g., during which an operating system hosted by hardware resources 150 is not in an operable state), (iii) receiving a notification regarding a potentially compromised state of the firewall hosted by hardware resources 150, and/or any other processes.

At operation 302, network data directed to the hardware resources may be intercepted by management controller 152. The network data may be intercepted by: (i) providing, to network module 160, a network addressable endpoint of management controller 152 to receive the network data, (ii) providing instructions to prevent the network data from reaching hardware resources 150, (iii) monitoring, by network module 160, incoming traffic from remote entities for network data directed to hardware resources 150, (iv) directing the network data to management controller 152 using the network addressable endpoint of management controller 152, and/or performing any other actions.

At operation 304, the network data may be screened by the management controller to identify a privileged portion of the network data and an unprivileged portion of the network data. The network data may be screened by: (i) comparing an identify of a source of the network data (e.g., an internet protocol address of a remote entity) to a whitelist to identify allowable sources of the network data, (ii) comparing an identify of the source to a blacklist to identify restricted sources of the network data, (iii) analyzing traffic patterns to identify potential communication activity that does not adhere to the firewall policy, (iv) discarding portions of unprivileged data, and/or performing any other actions.

At operation 306, the privileged portion of the network data may be redirected to the hardware resources. The privileged portion of the network data may be redirected by: (i) transmitting (e.g., via a side-band communication channel) a message including the privileged portion of the network data to hardware resources 150, (ii) repackaging the privileged portion of the network data, (iii) storing the screened data in memory for subsequent retrieval by hardware resources 150, and/or performing any other actions.

At operation 308, computer-implemented services may be provided by the hardware resources using the privileged portion of the network data. The computer-implemented services may be provided by: (i) using the privileged portion of the network data to modify a functionality of the hardware resources, (ii) pushing updates to a driver and/or a device based on obtained network data, (iii) modifying access to system resources (e.g., input/output ports, devices, etc.) based on the obtained network data, and/or any other processes.

The method may end following operation 308.

Using the method shown in FIG. 3, additional data processing systems in a distributed environment may seamlessly establish a shared wireless connection with a first data processing system while cooperatively providing computer-implemented services.

Any of the components illustrated in FIGS. 1A-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing network communications for a data processing system, the method comprising:
identifying, by a management controller of the data processing system, an indicator of an unavailability of a firewall hosted by hardware resources of the data processing system;
based on the identifying:
intercepting, by the management controller, network data directed to the hardware resources, the network data comprising messages sent between a remote entity and the data processing system to support operation of the data processing system;
screening, by the management controller, the network data based on a firewall policy to identify a privileged portion of the network data and an unprivileged portion of the network data;
redirecting, by the management controller, the privileged portion of the network data to the hardware resources and prevent the unprivileged portion of the network data from reaching the hardware resources; and
providing, by the hardware resources, computer-implemented services using the privileged portion of the network data.

2. The method of claim 1, wherein identifying the indicator of an unavailability of the firewall comprises:
monitoring a power state of the hardware resources of the data processing system;
identifying that the hardware resources are performing a booting process; and
identifying that the hardware resources are in a potentially compromised state with respect to the firewall.

3. The method of claim 2, wherein the firewall is unavailable when an operating system hosted by the hardware resources is not in an operable state based on the power state of the hardware resources and/or the booting process performed by the hardware resources.

4. The method of claim 1, wherein intercepting the network data comprises:
providing, by the management controller, instructions for a network module of the data processing system to redirect the network data to the management controller.

5. The method of claim 4, wherein the hardware resources and the network module are adapted to separately advertise network endpoints for the management controller and the hardware resources, the network endpoints being usable by the remote entity to address communications to the hardware resources using an in-band communication channel and the management controller using an out-of-band communication channel.

6. The method of claim 5, wherein the management controller and the network module are on separate power domains from the hardware resources so that the management controller and the network module are operable while the hardware resources are inoperable.

7. The method of claim 5, wherein the out-of-band communication channel runs through the network module, and an in-band communication channel that services the hardware resources also runs through the network module.

8. The method of claim 5, wherein the network module hosts a transmission control protocol/internet protocol (TCP/IP) stack to facilitate network communications via the out-of-band communication channel.

9. The method of claim 1, wherein the firewall policy comprises a set of rules for preventing unauthorized communication between remote entities and the hardware resources.

10. The method of claim 9, wherein screening the network data comprises performing at least one action from a group of actions consisting of:
comparing an identity of the remote entity to a whitelist and/or a blacklist indicated by the set of rules; and
analyzing traffic patterns to identify potential communication activity that does not adhere to the firewall policy.

11. The method of claim 1, wherein redirecting the privileged portion of the network data comprises:
forwarding the privileged portion of the network data to the hardware resources via a side band communication channel.

12. A non-transitory machine-readable medium having instructions stored therein, which when executed by a processor, cause the processor to perform operations for managing network communications for a data processing system, the operations comprising:
identifying, by a management controller of the data processing system, an indicator of an unavailability of a firewall hosted by hardware resources of the data processing system;
based on the identifying:
intercepting, by the management controller, network data directed to the hardware resources, the network data comprising messages sent between a remote entity and the data processing system to support operation of the data processing system;
screening, by the management controller, the network data based on a firewall policy to identify a privileged portion of the network data and an unprivileged portion of the network data;
redirecting, by the management controller, the privileged portion of the network data to the hardware resources and prevent the unprivileged portion of the network data from reaching the hardware resources; and
providing, by the hardware resources, computer-implemented services using the privileged portion of the network data.

13. The non-transitory machine-readable medium of claim 12, wherein identifying the indicator of an unavailability of the firewall comprises:
monitoring a power state of the hardware resources of the data processing system;
identifying that the hardware resources are performing a booting process; and
identifying that the hardware resources are in a potentially compromised state with respect to the firewall.

14. The non-transitory machine-readable medium of claim 13, wherein the firewall is unavailable when an operating system hosted by the hardware resources is not in an operable state based on the power state of the hardware resources and/or the booting process performed by the hardware resources.

15. The non-transitory machine-readable medium of claim 12, wherein intercepting the network data comprises:
providing, by the management controller, instructions for a network module of the data processing system to redirect the network data to the management controller.

16. The non-transitory machine-readable medium of claim 15, wherein the hardware resources and the network module are adapted to separately advertise network endpoints for the management controller and the hardware resources, the network endpoints being usable by the remote entity to address communications to the hardware resources using an in-band communication channel and the management controller using an out-of-band communication channel.

17. A data processing system, comprising:
a processor; and
a memory coupled to the processor to store instructions, which when executed by the processor, cause the processor to perform operations for managing network communications for the data processing system, the operations comprising:
identifying, by a management controller of the data processing system, an indicator of an unavailability of a firewall hosted by hardware resources of the data processing system;
based on the identifying:
intercepting, by the management controller, network data directed to the hardware resources, the network data comprising messages sent between a remote entity and the data processing system to support operation of the data processing system;
screening, by the management controller, the network data based on a firewall policy to identify a privileged portion of the network data and an unprivileged portion of the network data;
redirecting, by the management controller, the privileged portion of the network data to the hardware resources and prevent the unprivileged portion of the network data from reaching the hardware resources; and
providing, by the hardware resources, computer-implemented services using the privileged portion of the network data.

18. The data processing system of claim 17, wherein identifying the indicator of an unavailability of the firewall comprises:
monitoring a power state of the hardware resources of the data processing system;
identifying that the hardware resources are performing a booting process; and
identifying that the hardware resources are in a potentially compromised state with respect to the firewall.

19. The data processing system of claim 18, wherein the firewall is unavailable when an operating system hosted by the hardware resources is not in an operable state based on the power state of the hardware resources and/or the booting process performed by the hardware resources.

20. The data processing system of claim 17, wherein intercepting the network data comprises: providing, by the management controller, instructions for a network module of the data processing system to redirect the network data to the management controller.
